(19) United States
(12) Patent Application Publication
(10) Pub. No.: US 2009/0276314 A1
(43) Pub. Date: Nov. 5, 2009

(54) ADVERTISING SUPPORTED VPN

(75) Inventors: David GORODYANSKY, Sunnyvale, CA (US); Eugene Malobrodsky, Cupertino, CA (US); Eugene Lapidous, Saratoga, CA (US)

Correspondence Address: SUGHRUE MION, PLLC, 2100 PENNSYLVANIA AVENUE, N.W., SUITE 800, WASHINGTON, DC, 20037, US

(73) Assignee: ANCHORFREE, INC., Sunnyvale, CA (US)

(21) Appl. No.: 12/418,514

(22) Filed: Apr. 3, 2009

Related U.S. Application Data
(60) Provisional application No. 61/042,692, filed on Apr. 4, 2008.

(51) Int. Cl. G06Q 30/00; G06F 21/00

(52) U.S. Cl. 705/14.53; 726/15; 705/14.69; 705/14.55; 705/14.73; 705/34

(57) ABSTRACT

Described is a computerized system including a virtual private network server operable to provide a virtual private network service, the virtual private network service enabling a user to retrieve at least one internet resource; and an advertisement module operable to furnish advertisements for insertion into the internet resource retrieved by the user using the virtual private network service. In the inventive system, the revenue generated through the insertion of the advertisement is used to subsidize the virtual private network service. In accordance with another aspect, there is provided a method involving retrieving at least one internet resource using a virtual private network service and inserting an advertisement into the retrieved internet resource. In the inventive method, the revenue generated through the insertion of the advertisement is used to subsidize the virtual private network service.

### CROSS-REFERENCE TO RELATED APPLICATION

This regular U.S. patent application is based on and claims the benefit of priority under 35 U.S.C. 119 from provisional U.S. patent application No. 61/042,692, filed on Apr. 4, 2008, the entire disclosure of which is incorporated by reference herein.

### FIELD OF THE INVENTION

The present invention relates generally to advertising on the Internet and more specifically to enabling virtual private network (VPN) services subsidized through advertising.

### DESCRIPTION OF THE RELATED ART

Virtual private networks (VPNs) can be used to provide a layer of security and anonymity to internet users. Specifically, in a typical configuration, a secure VPN connection is established between a user's terminal 101 and a VPN server 102, as shown in FIG. 1. According to the conventional VPN protocol, the user terminal 101 sends a request 104 to the VPN server 102 for the internet resource 103. The request 104 may be sent via a secure channel, wherein all the transmitted information is encrypted. In response to receiving the request 104, the VPN server 102 sends a request 105 to the internet resource 103 requested by the user. However, the VPN server 102 is configured to mask the information identifying the user terminal 101 from the request 105. Such information that is being masked includes, for example, user's IP address. Upon the receipt of the request 105, the internet resource 103 provides a response 106 to the VPN server 102. The VPN server 102, in turn, forwards (107) this response to the client 101 via a secure channel. Because of the presence of the secure channel 104/107 and the masking of the IP address by the VPN 102, the internet resource 103 or any other internet entity does not detect any information identifying the client terminal 101, which initiated the request. Thus, user's security and anonymity is achieved.

All existing VPN service providers charge users for the use of their VPN services. There is no existing system, in which the use of the VPN services is subsidized based on advertising provided to the user using such VPN service.

### SUMMARY OF THE INVENTION

The inventive methodology is directed to methods and systems that substantially obviate one or more of the above and other problems associated with conventional techniques for providing VPN services.

In accordance with one aspect of the inventive concept, there is provided a computerized system including a virtual private network server operable to provide a virtual private network service, the virtual private network service enabling a user to retrieve at least one internet resource; and an advertisement module operable to furnish advertisements for insertion into the internet resource retrieved by the user using the virtual private network service. In the inventive system, the revenue generated through the insertion of the advertisement is used to subsidize the virtual private network service.

In accordance with another aspect of the inventive concept, there is provided a method involving: retrieving at least one internet resource using a virtual private network service and inserting an advertisement into the retrieved internet resource. In the inventive method, the revenue generated through the insertion of the advertisement is used to subsidize the virtual private network service.

Additional aspects related to the invention will be set forth in part in the description which follows, and in part will be obvious from the description, or may be learned by practice of the invention. Aspects of the invention may be realized and attained by means of the elements and combinations of various elements and aspects particularly pointed out in the following detailed description and the appended claims.

It is to be understood that both the foregoing and the following descriptions are exemplary and explanatory only and are not intended to limit the claimed invention or application thereof in any manner whatsoever.

### BRIEF DESCRIPTION OF THE DRAWINGS

The accompanying drawings, which are incorporated in and constitute a part of this specification exemplify the embodiments of the present invention and, together with the description, serve to explain and illustrate principles of the inventive technique. Specifically:

FIG. 1 illustrates a schematic diagram of an exemplary VPN implementation.

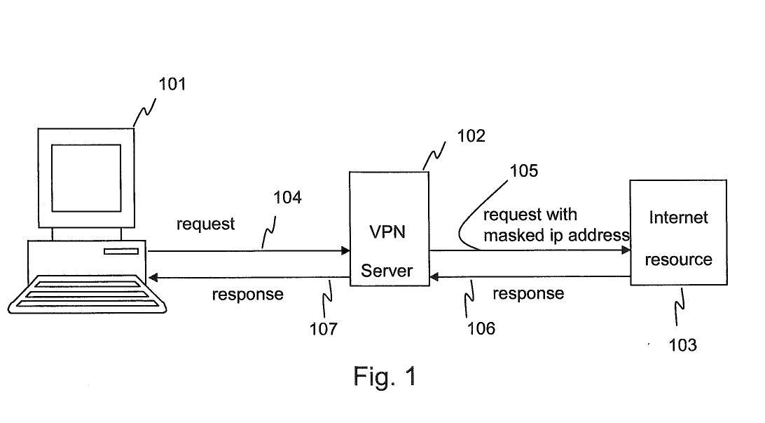

FIG. 2 illustrates an exemplary embodiment of inventive advertising-subsidized VPN system.

FIG. 3 illustrates another exemplary embodiment of inventive advertising-subsidized VPN system.

FIG. 4 illustrates yet another exemplary embodiment of inventive advertising-subsidized VPN system.

FIG. 5 illustrates an exemplary embodiment of a computer platform upon which the inventive system may be implemented.

### DETAILED DESCRIPTION

In the following detailed description, reference will be made to the accompanying drawing(s), in which identical functional elements are designated with like numerals. The aforementioned accompanying drawings show by way of illustration, and not by way of limitation, specific embodiments and implementations consistent with principles of the present invention. These implementations are described in sufficient detail to enable those skilled in the art to practice the invention and it is to be understood that other implementations may be utilized and that structural changes and/or substitutions of various elements may be made without departing from the scope and spirit of present invention. The following detailed description is, therefore, not to be construed in a limited sense. Additionally, the various embodiments of the invention as described may be implemented in the form of software running on a general purpose computer, in the form of a specialized hardware, or combination of software and hardware.

In accordance with an embodiment of the inventive system, there is provided advertising targeting based on user geo preference. First, the user selects different geo regions (country, zip code) to be presented to content providers and advertisers, while real user's geo region remains the same. The advertisement requests sent to the same database contain different geo region identifiers as selected by the user. In accordance with an embodiment of the invention, same user, connected to the same proxy server, receives different geo-targeted ads depending on the user's selection of geo region.

In accordance with an embodiment of this invention, geographical preference information is made specific to a particular internet site or to a particular content request. For example, user may specify a preference for the IP address from the United Kingdom for requests to all domains registered in the UK (for instance, ending with “co.uk”), or only for requests to specific sites (for instance, http://www.bbc.co.uk), while also specifying preferences for IP addresses from the United States for all other content requests. In this way, users will enjoy content allowed only for requests with UK-specific IP addresses (such as UK-specific video content from http://www.bbc.co.uk), while receiving content targeted to US users from other sites (such as US-specific video content from http://www.hulu.com). In accordance with one embodiment of the invention, site-specific geographic preference is applied both to the content and to one or more advertisements displayed on the site. In accordance with one embodiment of the invention, site-specific geographic preference is applied both to the content and to one or more advertisements displayed on the site. In accordance with another embodiment of the present invention, different content elements on the same web page may be associated with different geographic preferences. For instance, user may receive content from UK-based sites in response to a request issued from UK-based IP addresses, while receiving advertisements displayed on that site in response to a request issued from US-based IP addresses.

In accordance with a feature of the inventive methodology, the virtual private network server is operable to receive from the user a selection of language wherein the virtual private network server is further operable to alter the user's online identity to reflect the selected language. The selection of the language indicates preferred content display language of the user and the online content of the user defers depending on the language selection.

In accordance with an embodiment of the inventive system, there is provided a method for using one server with multiple IP addresses. Pursuant to the inventive method, the service has at least one proxy server capable of sending requests to the content servers while using any of 2 or more IP addresses belonging to different countries; user specifies conditions of IP address to use when establishing tunnel (for instance, country); request from the proxy server to the content server is sent while using IP address corresponding to specified conditions.

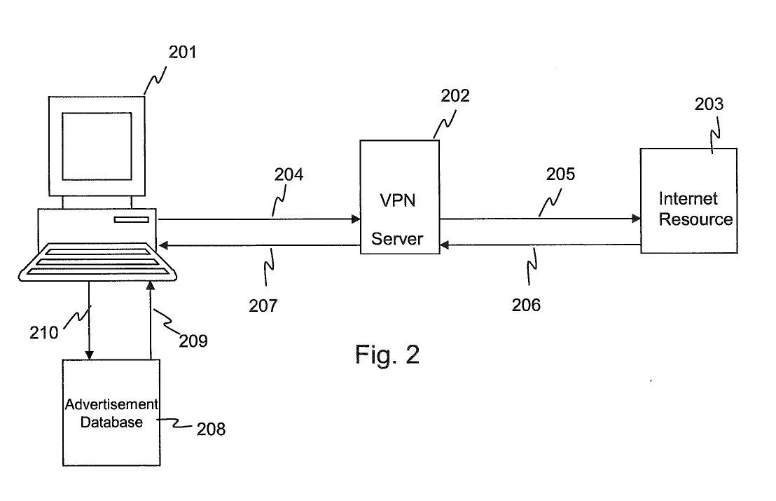

FIG. 2 illustrates an exemplary embodiment of inventive advertising-subsidized VPN system. In an embodiment of the inventive system, the client terminal 201 executes a VPN client software (not shown). This VPN client software operates to insert advertisements into every web resource (such as web page) received by the client terminal 201 from the VPN server 202.

The user terminal 201 first sends a request 204 to the VPN server 202 for the internet resource 203. The request 204 may be sent via a secure channel, wherein all the transmitted information is encrypted. In response to receiving the request 204, the VPN server 202 sends a request 205 to the internet resource 203 requested by the user. However, the VPN server 202 is configured to mask the information identifying the user terminal 201 from the request 205. Such information that is being masked includes, for example, user's IP address. Upon the receipt of the request 205, the internet resource 203 provides a response 206 to the VPN server 202. The VPN server 202, in turn, forwards (207) this response to the client 201 via a secure channel. Because of the presence of the secure channel 204/207 and the masking of the IP address by the VPN 202, the internet resource 203 or any other internet entity does not detect any information identifying the client terminal 201, which initiated the request. Thus, user's security and anonymity is achieved.

To subsidize the costs of such service, advertisements are shown to the users. Specifically, upon the receipt of the response 207 from the VPN server 202, the VPN client software executing on the user terminal 201 operates to insert one or more advertisements into the information shown to the user of the user terminal 201. In an embodiment of the invention shown in FIG. 2, the client terminal 201 receives the advertisements to be inserted into the content from the advertisement database 208. To this end, the client terminal 201 may send a request 209 to the advertisement database 208. In response, the advertisement 210 is provided by the advertisement database 208 to the user terminal 201.

In one embodiment of the invention, the advertisements served to the users are targeted based on the user's online behavior. To this end, the VPN client software or any other software application executing on the client terminal is operable to collect information on the user's online activities and store this information for subsequent use. At the time of the user request 204 or at the time the information 207 is received by the user terminal 201, the VPN software residing on the client terminal 201 may make a determination regarding the nature of the advertisement to be shown to the user. The decision on the type of the advertisement may be based on the user's prior online activities stored at the client terminal 201 as well as the nature of the user's request 204 and/or the nature of the information 207.

Thus, in one embodiment of the invention, the all the user-specific information, including the online history of the user is stored only on the client terminal 201 and never on the server 202 or any other server system. Thus, the privacy of the user information is achieved.

Thus, the request 209 to the advertisement database 208 may include information on the type of the advertisement to be provided to the user terminal. The information in the advertisement database 208 may be updated periodically in order to ensure that it is up to date. The owner of the VPN service and the advertising database 208 may charge third parties for placing their advertisement into the advertising database 208 and, thereby, subsidize the costs of the VPN service.

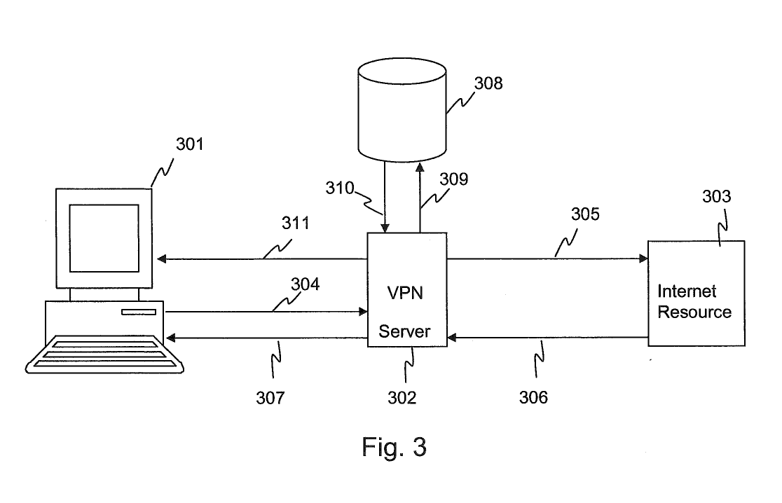

FIG. 3 is a block diagram illustrating another exemplary embodiment of inventive advertising-subsidized VPN system. In this embodiment, the advertising database 308 is coupled with a VPN server 302, which operates to request an advertisement from the advertising database 308 using a request 309 and to receive the advertisement 310. After that, the VPN server 302 forwards the received advertisement to the client terminal 302, see 311. In this embodiment, the information specifying the advertisement, which is contained in the request 309 may be provided to the VPN service by the user terminal 301, being embedded, for example, into the request 304. In another embodiment, the user terminal may send a separate special request to the VPN server for advertising information (not shown). As in the embodiment shown in FIG. 2, the decision on the type of the advertisement may be based on the user's prior online activities stored at the client terminal 301 as well as the nature of the user's request 304 and/or the nature of the information 307.

In one embodiment of the inventive system, the VPN client software residing on the client terminal operates to disable all tracking cookies, which are normally set by various websites visited by the user. This provides the users with an additional degree of anonymity with respect to user's online activities.

In one embodiment, the inventive advertisement sponsored VPN system may utilize the client side user data collection and advertisement insertion algorithm described in detail in U.S. patent application Ser. No. 11/471,247, incorporated by reference herein in its entirety. In that or another embodiment, the inventive advertisement sponsored VPN server may be implemented using one or more features of the networking device with embedded advanced content and web traffic monetization functionality, as described in detail in U.S. patent application Ser. No. 11/513,674, incorporated by reference herein in its entirety.

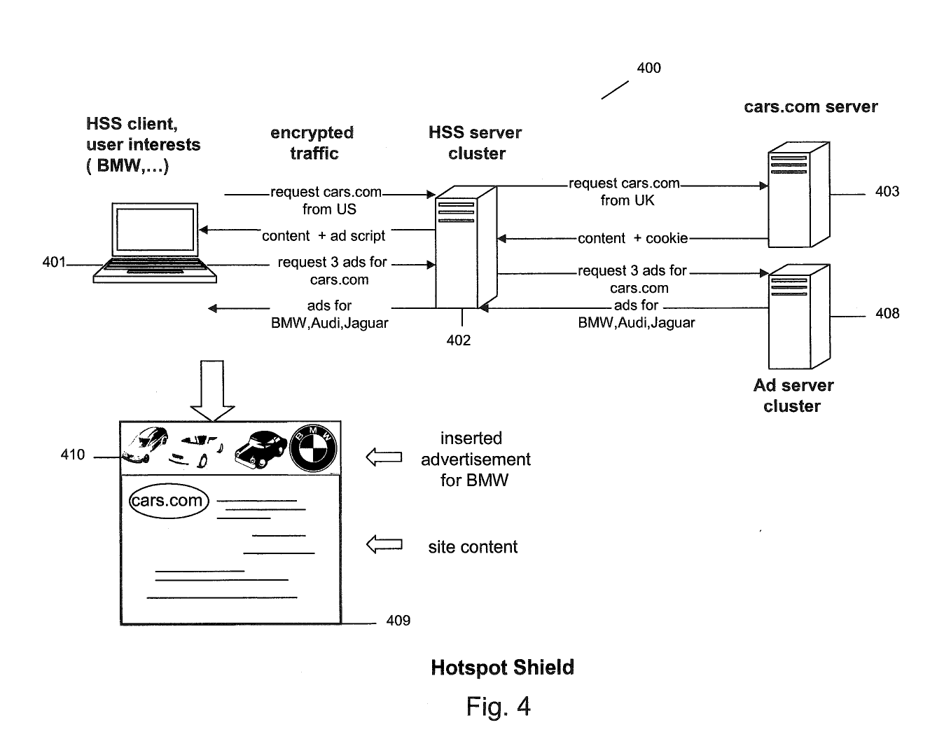

FIG. 4 illustrates another exemplary embodiment of the inventive ad supported VPN system 400. The user of the client system 401, located in the US, makes a request for cars.com web page. The request is sent to the HSS server cluster 402 via an encrypted traffic channel. The HSS server cluster alters the identity information associated with the request. Specifically, the HSS server associates the request with an IP address in United Kingdom. The altered request is sent to the cars.com server 403. The cars.com server responds to the HSS server cluster 402 with content and a cookie. The HSS server cluster passes the content to the client 401 and disposes of the cookie. Together with the content, the HSS server cluster includes an ad script, which enables ad showing to the user of the client 401. At the same time, the client software executing on the system 401 makes a request to the HSS server cluster 402 for three advertisements. This request is passed by the HSS server to the Ad server cluster 408, which provides the three advertisements related to BMW, Audi and Jaguar to the HSS server cluster 402, which, in turn passes the ads to the client 401. The client software running on the system 401 chooses the most relevant ad based on, for example, prior online activities of the user and inserts this ad (BMW ad 410) into the content 409 and shows it to the user. In another embodiment, the most relevant ad may be selected using the location of the user which may be determined from user's IP address.

In one embodiment of the invention, the user is provided with an ability to select any IP address (from a choice of IP addresses corresponding to multiple counties) through the inventive VPN, thus enabling the user to choose what region of the world would be reflected his online identity. In the same or another embodiment of the invention, the user may select a language from a predetermined set of world languages that the user prefers or wishes to receive the content in.

The above features of the inventive methodology disrupt the ability of the ISP or governments to block particular internet sites or online services in a given region, and creates a completely censorship free Internet experience.

In one embodiment of the inventive system, one server with multiple IP addresses is used. The service has at least one proxy server capable of sending requests to the content servers while using any of 2 or more IP addresses belonging to different countries. In accordance with an embodiment of the inventive concept, the user is able to specify conditions of IP address to use when establishing the tunnel (for instance, country or language) request from the proxy server to the content server is sent while using IP address corresponding to specified conditions.

In accordance with another embodiment of the invention, the inventive system provides advertisement targeting based on the user's IP address selection or language selection. In one embodiment of the invention, the user's language selection is used by the inventive system to choose the language in which the advertisement is presented to the user. In one embodiment of the invention, the user selects different geographical regions (country, zip code or language) to be presented to content providers and advertisers, while real user's geo region remains the same. The ad requests sent to the same database contain different geo region identifiers as selected by the user. The same user, connected to the same proxy server, receives different geo-targeted ads depending on the user's selection of geo region.

In an embodiment of the invention, the content server 403 or the proxy server 402 reads user's preference (from user-submitted form, or selection of the region on the map etc., stored as session or cookie) and sends it together with advertisement request to the advertising server 408.

In one embodiment, the inventive advertising supported VPN, in addition to masking user IP address, not storing the user IP address, and preventing third parties from analyzing user behavior by making users private only, also turns all HTTP web traffic into HTTPS secure traffic. Protecting all user data online (such as forms, logins, emails, transactions, etc.) and creating encryption for each user's entire web session. This also enables an exchange between a website and the advertising supported VPN; every website that is turned from HTTP into HTTPS (secure & encrypted) by the VPN, in exchange displays an extra ad unit within its content or within the users browser. The embodiment of the advertising supported VPN takes on the encryption, in exchange for providing encryption to websites, content publishers and online services and while protecting each user's entire web session, by converting all traffic into HTTPS.

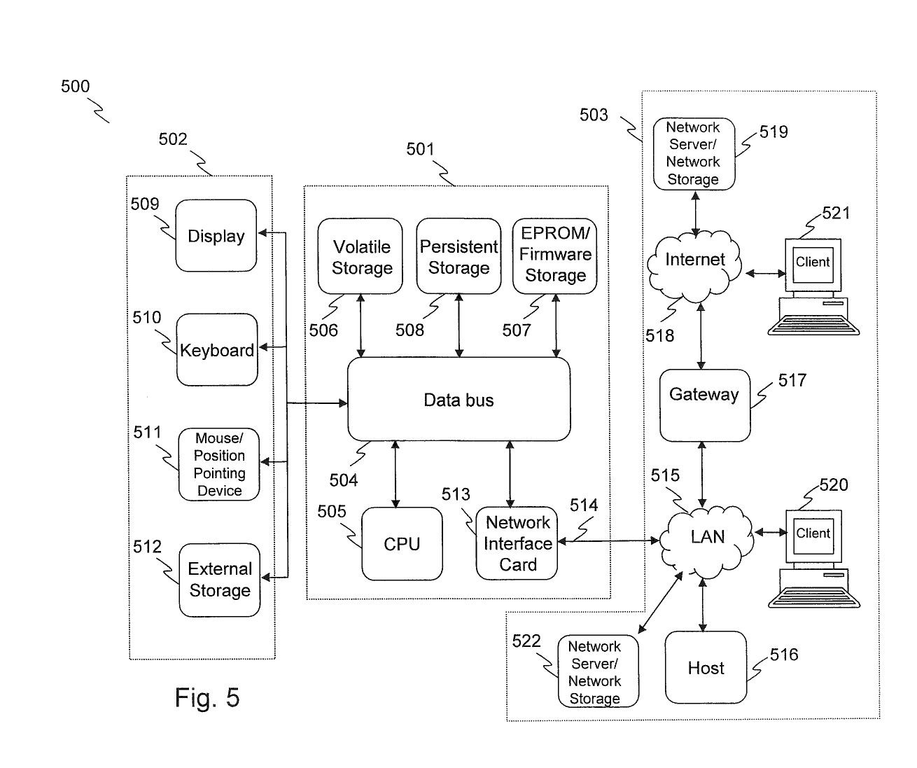

FIG. 5 is a block diagram that illustrates an embodiment of a computer/server system 500 upon which an embodiment of the inventive methodology may be implemented. The system 500 includes a computer/server platform 501, peripheral devices 502 and network resources 503.

The computer platform 501 may include a data bus 504 or other communication mechanism for communicating information across and among various parts of the computer platform 501, and a processor 505 coupled with bus 501 for processing information and performing other computational and control tasks. Computer platform 501 also includes a volatile storage 506, such as a random access memory (RAM) or other dynamic storage device, coupled to bus 504 for storing various information as well as instructions to be executed by processor 505. The volatile storage 506 also may be used for storing temporary variables or other intermediate information during execution of instructions by processor 505. Computer platform 501 may further include a read only memory (ROM or EPROM) 507 or other static storage device coupled to bus 504 for storing static information and instructions for processor 505, such as basic input-output system (BIOS), as well as various system configuration parameters. A persistent storage device 508, such as a magnetic disk, optical disk, or solid-state flash memory device is provided and coupled to bus 501 for storing information and instructions.

Computer platform 501 may be coupled via bus 504 to a display 509, such as a cathode ray tube (CRT), plasma display, or a liquid crystal display (LCD), for displaying information to a system administrator or user of the computer platform 501. An input device 510, including alphanumeric and other keys, is coupled to bus 501 for communicating information and command selections to processor 505. Another type of user input device is cursor control device 511, such as a mouse, a trackball, or cursor direction keys for communicating direction information and command selections to processor 504 and for controlling cursor movement on display 509. This input device typically has two degrees of freedom in two axes, a first axis (e.g., x) and a second axis (e.g., y), that allows the device to specify positions in a plane.

An external storage device 512 may be connected to the computer platform 501 via bus 504 to provide an extra or removable storage capacity for the computer platform 501. In an embodiment of the computer system 500, the external removable storage device 512 may be used to facilitate exchange of data with other computer systems.

The invention is related to the use of computer system 500 for implementing the techniques described herein. In an embodiment, the inventive server 103 may reside on a machine such as computer platform 501. In an embodiment, the location database 104 may also be deployed on a machine such as computer platform 501. According to one embodiment of the invention, the techniques described herein are performed by computer system 500 in response to processor 505 executing one or more sequences of one or more instructions contained in the volatile memory 506. Such instructions may be read into volatile memory 506 from another computer-readable medium, such as persistent storage device 508. Execution of the sequences of instructions contained in the volatile memory 506 causes processor 505 to perform the process steps described herein. In alternative embodiments, hard-wired circuitry may be used in place of or in combination with software instructions to implement the invention. Thus, embodiments of the invention are not limited to any specific combination of hardware circuitry and software.

The term “computer-readable medium” as used herein refers to any medium that participates in providing instructions to processor 505 for execution. The computer-readable medium is just one example of a machine-readable medium, which may carry instructions for implementing any of the methods and/or techniques described herein. Such a medium may take many forms, including but not limited to, non-volatile media, volatile media, and transmission media. Non-volatile media includes, for example, optical or magnetic disks, such as storage device 508. Volatile media includes dynamic memory, such as volatile storage 506. Transmission media includes coaxial cables, copper wire and fiber optics, including the wires that comprise data bus 504. Transmission media can also take the form of acoustic or light waves, such as those generated during radio-wave and infra-red data communications.

Common forms of computer-readable media include, for example, a floppy disk, a flexible disk, hard disk, magnetic tape, or any other magnetic medium, a CD-ROM, any other optical medium, punch cards, paper tape, any other physical medium with patterns of holes, a RAM, a PROM, an EPROM, a FLASH-EPROM, a flash drive, a memory card, any other memory chip or cartridge, a carrier wave as described hereinafter, or any other medium from which a computer can read.

Various forms of computer readable media may be involved in carrying one or more sequences of one or more instructions to processor 505 for execution. For example, the instructions may initially be carried on a magnetic disk from a remote computer. Alternatively, a remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on the data bus 504. The bus 504 carries the data to the volatile storage 506, from which processor 505 retrieves and executes the instructions. The instructions received by the volatile memory 506 may optionally be stored on persistent storage device 508 either before or after execution by processor 505. The instructions may also be downloaded into the computer platform 501 via Internet using a variety of network data communication protocols well known in the art.

The computer platform 501 also includes a communication interface, such as network interface card 513 coupled to the data bus 504. Communication interface 513 provides a two-way data communication coupling to a network link 514 that is connected to a local network 515. For example, communication interface 513 may be an integrated services digital network (ISDN) card or a modem to provide a data communication connection to a corresponding type of telephone line. As another example, communication interface 513 may be a local area network interface card (LAN NIC) to provide a data communication connection to a compatible LAN. Wireless links, such as well-known 802.11a, 802.11b, 802.11g and Bluetooth may also used for network implementation. In any such implementation, communication interface 513 sends and receives electrical, electromagnetic or optical signals that carry digital data streams representing various types of information.

Network link 513 typically provides data communication through one or more networks to other network resources. For example, network link 514 may provide a connection through local network 515 to a host computer 516, or a network storage/server 517. Additionally or alternatively, the network link 513 may connect through gateway/firewall 517 to the wide-area or global network 518, such as an Internet. Thus, the computer platform 501 can access network resources located anywhere on the Internet 518, such as a remote network storage/server 519. On the other hand, the computer platform 501 may also be accessed by clients located anywhere on the local area network 515 and/or the Internet 518. The network clients 520 and 521 may themselves be implemented based on the computer platform similar to the platform 501.

Local network 515 and the Internet 518 both use electrical, electromagnetic or optical signals that carry digital data streams. The signals through the various networks and the signals on network link 514 and through communication interface 513, which carry the digital data to and from computer platform 501, are exemplary forms of carrier waves transporting the information.

Computer platform 501 can send messages and receive data, including program code, through the variety of network(s) including Internet 518 and LAN 515, network link 514 and communication interface 513. In the Internet example, when the system 501 acts as a network server, it might transmit a requested code or data for an application program running on client(s) 520 and/or 521 through Internet 518, gateway/firewall 517, local area network 515 and communication interface 513. Similarly, it may receive code from other network resources.

The received code may be executed by processor 505 as it is received, and/or stored in persistent or volatile storage devices 508 and 506, respectively, or other non-volatile storage for later execution. In this manner, computer system 501 may obtain application code in the form of a carrier wave.

It should be noted that the present invention is not limited to any specific types of wireless or wired network protocols. The requisite network configuration may be achieved using a variety of known networking protocols.

Finally, it should be understood that processes and techniques described herein are not inherently related to any particular apparatus and may be implemented by any suitable combination of components. Further, various types of general purpose devices may be used in accordance with the teachings described herein. It may also prove advantageous to construct specialized apparatus to perform the method steps described herein. The present invention has been described in relation to particular examples, which are intended in all respects to be illustrative rather than restrictive. Those skilled in the art will appreciate that many different combinations of hardware, software, and firmware will be suitable for practicing the present invention. For example, the described software may be implemented in a wide variety of programming or scripting languages, such as Assembler, C/C++, perl, shell, PHP, Java, etc.

Moreover, other implementations of the invention will be apparent to those skilled in the art from consideration of the specification and practice of the invention disclosed herein. Various aspects and/or components of the described embodiments may be used singly or in any combination in the computerized system for providing VPN services. It is intended that the specification and examples be considered as exemplary only, with a true scope and spirit of the invention being indicated by the following claims.

What is claimed is:

1. A computerized system comprising:
a. A virtual private network server operable to provide a virtual private network service, the virtual private network service enabling a user to retrieve at least one internet resource; and
b. An advertisement module operable to furnish advertisements for insertion into the internet resource retrieved by the user using the virtual private network service, wherein revenue generated through the insertion of the advertisement is used to subsidize the virtual private network service.

2. The computerized system of claim 1, wherein the virtual private network service is operable to conceal an identity of the user retrieving the at least one internet resource.

3. The system of claim 1, wherein the virtual private network server is operable to receive from the user a selection of a geographical region and wherein the virtual private network server is further operable to alter the user's online identity to reflect an IP address corresponding to the selected geographical region.

4. The system of claim 1, wherein the virtual private network server is operable to receive from the user selection of a language from a plurality of predetermined languages, wherein the selection of the language indicates preferred content display language of the user and wherein online content of the user defers depending on the language selection.

5. The system of claim 4, further comprising a client system operable to receive a plurality of advertisements from the advertisement module and to choose a most relevant advertisement based on the selected geographical region or the user selection of the language.

6. The system of claim 1, wherein the virtual private network server is operable to receive from the user a selection of IP address corresponding to a particular geographical region and wherein the virtual private network server is further operable to alter the user's online identity to reflect the selected IP address.

7. The system of claim 1, wherein the virtual private network server is operable to receive from the user a selection of language wherein the virtual private network server is further operable to alter the user's online identity to reflect the selected language.

8. The system of claim 7, further comprising a client system operable to receive a plurality of advertisements from the advertisement module and to choose a most relevant advertisement based on the selected IP address or the selected language.

9. A method comprising:
a. Retrieving at least one internet resource using a virtual private network service;
b. Inserting an advertisement into the retrieved internet resource, wherein revenue generated through the insertion of the advertisement is used to subsidize the virtual private network service;
c. Displaying the advertisement on a display to the user.

10. The method of claim 9, further comprising receiving from the user a selection of a geographical region and altering the user's online identity to reflect an IP address corresponding to the selected geographical region.

11. The method of claim 10, further comprising receiving a plurality of advertisements from the advertisement module and to choosing a most relevant advertisement based on the selected geographical region.

12. A method for advertising targeting based on a geographical preference of a user, the method comprising:
a. Receiving geographical preference information from the user, the geographical preference comprising a selection of a geographical region of interest from a plurality of geographical regions of interest;
b. Continuing to provide the user with advertising materials in accordance with the user geographical preference information; and
c. Displaying the advertising materials on a display to the user.

13. The method of claim 12, wherein the geographical preference information is specific to a particular internet site and wherein the advertising materials comprise information on products and services associated with the selected geographical region of interest.

14. A virtual private network server operable to provide a virtual private network service, the virtual private network service enabling a user to retrieve at least one internet resource, wherein the virtual private network server is operable to receive from the user a selection of a geographical region and wherein the virtual private network server is further operable to alter the user's online identity to reflect an IP address corresponding to the selected geographical region.

15. The virtual private network server of claim 14, further comprising a billing module operable to issue billing information to a user of the virtual private network.

16. The virtual private network server of claim 14, wherein the virtual private network service is a fee subsidized service.

17. A virtual private network server operable to provide a virtual private network service, the virtual private network service enabling a user to retrieve at least one internet resource, wherein the virtual private network server is operable to receive from the user a selection of IP address corresponding to a particular geographical region and wherein the virtual private network server is further operable to alter the user's online identity to reflect the selected IP address.

18. The virtual private network server of claim 17, further comprising a billing module operable to issue billing information to a user of the virtual private network.

19. The virtual private network server of claim 17, wherein the virtual private network service is a fee subsidized service.
